(19) United States
(12) Patent Application Publication
(10) Pub. No.: US 2025/0347313 A1
(43) Pub. Date: Nov. 13, 2025

(54) ROTATING SHAFT STRUCTURE FOR POLISHER

(71) Applicant: ZHIBING WANG, Leiyang (CN)

(72) Inventor: ZHIBING WANG, Leiyang (CN)

(21) Appl. No.: 18/798,077

(22) Filed: Aug. 8, 2024

(30) Foreign Application Priority Data
May 13, 2024 (CN) 202421026156.2

(51) Int. Cl. F16C 3/02

(52) U.S. Cl. CPC F16C 3/02; F16C 2314/00

(57) ABSTRACT

Disclosed is a rotating shaft structure for a polisher. The rotating shaft structure includes a shaft rod and a shaft sleeve, and further includes a shaft housing, a first clamping member, a second clamping member, and a third clamping member. One end of the shaft rod is connected to the shaft sleeve, and the other end of the shaft rod is connected to the third clamping member. One end of the third clamping member away from the shaft rod is provided with an openable clamping mouth. The first clamping member is in a hollow tubular shape. The second clamping member and the third clamping member are both located in the first clamping member, and the second clamping member is located at one side of the third clamping member away from the shaft rod. One end of the second clamping member sleeves the clamping mouth of the third clamping member.

### CROSS-REFERENCE TO RELATED APPLICATIONS

This application claims priority to Chinese Patent Application No. 202421026156.2, filed on May 13, 2024, which is hereby incorporated by reference in its entirety.

### TECHNICAL FIELD

The present disclosure relates to the technical field of polishers, and particularly relates to a rotating shaft structure for a polisher.

### BACKGROUND

As people have higher requirements for their life quality, a hand-held nail polisher, a small household appliance, has been favored by women and pet lovers. Hand-held nail polishers have wired and wireless types. The wireless ones are powered by batteries. A main structure of a nail polisher includes a housing, a power supply module, a control module, a brushless motor, a rotating shaft structure, a polishing rod, etc. Its working principle is as follows: the polishing rod is connected to the rotating shaft structure, the rotating shaft structure is connected to the brushless motor, the power supply module supplies power to the brushless motor, the control module controls start or stop and a rotating speed of the brushless motor, and the brushless motor drives the rotating shaft structure and the polishing rod to rotate, such that a polishing function is implemented.

The polishing needs to be replaced frequently because it can wear during use and then its polishing effect declines and polishing rods varied in structures and sizes have different application scopes. In order to facilitate replacement of the polishing rod, facilitate user operation and improve user experience, the applicant proposed a rotating shaft structure for a polisher, a polishing rod of which can be replaced conveniently.

### SUMMARY

An objective of the present disclosure is to provide a rotating shaft structure for a polisher, which can facilitate replacement of a polishing rod, facilitate user operation, and improve user experience.

The present disclosure is implemented as follows: a rotating shaft structure for a polisher includes a shaft rod and a shaft sleeve, and further includes a shaft housing, a first clamping member, a second clamping member, and a third clamping member. One end of the shaft rod is connected to the shaft sleeve, and the other end of the shaft rod is connected to the third clamping member. One end of the third clamping member away from the shaft rod is provided with an openable clamping mouth. The first clamping member is in a hollow tubular shape. The second clamping member and the third clamping member are both located in the first clamping member, and the second clamping member is located at one side of the third clamping member away from the shaft rod. One end of the second clamping member sleeves the clamping mouth of the third clamping member. The first clamping member and the third clamping member are slidably connected one after another. The third clamping member is sleeved with a first spring. The third clamping member includes a second tubular part arranged on an outer wall of the third clamping member. One end of the first spring elastically abuts against the second tubular part, and the other end of the first spring elastically abuts against the second clamping member. The first spring abuts against the second clamping member by means of the second tubular part of the third clamping member, and an inner wall of the second clamping member presses the clamping mouth of the third clamping member, such that the clamping mouth of the third clamping member contracts to be in a clamped state.

Further, one end of the shaft rod is provided with a first tubular part. One end of the third clamping member is inserted into the first tubular part and rotates synchronously with the first tubular part. The third clamping member further includes a third tubular part. One end of the third tubular part opposite the first tubular part is provided with the clamping mouth. A wall of the clamping mouth is provided with a plurality of openable seams in a circumferential direction.

Further, an outer wall of the clamping mouth of the third tubular part is provided with a protruding structure. The second clamping member is in a hollow tubular shape. One end of the second clamping member extends out of the first clamping member, and the end, sleeving the clamping mouth, of the second clamping member is provided with a sleeving mouth having a diameter gradually decreased.

Further, the first clamping member includes a first mounting tubular part and a second mounting tubular part. An aperture of the first mounting tubular part is larger than an aperture of the second mounting tubular part. The second tubular part and the third tubular part of the third clamping member are both completely located in the first mounting tubular part. An outer diameter of the second tubular part is larger than the aperture of the second mounting tubular part. A length of the second tubular part is L1. A distance between the second tubular part and the protruding structure is L2. The first clamping member is fixedly connected to the second clamping member. The second clamping member is arranged in the first mounting tubular part of the first clamping member. A distance between the second clamping member and the second mounting tubular part is L3. L3 satisfies the following formula: L3<L1+L2.

Further, the shaft housing is internally provided with two bearings. The first clamping member is mounted in the two bearings, and two ends of the first clamping member penetrate two ends of the shaft housing. The shaft housing is further provided with a positioning ring and a second spring. The positioning ring and the second spring both sleeve the first clamping member. The second spring is pressed between the positioning ring and the bearing close to the shaft rod.

One end of the shaft housing close to the shaft rod is provided with an opening, and an inner wall of the end is provided with a threaded structure. A shaft cover is mounted on the threaded structure in a threaded manner. A middle portion of the shaft cover is provided with a through hole allowing the first clamping member to penetrate.

Further, one end of the shaft housing away from the shaft rod is provided with a through hole allowing the first clamping member to penetrate, and an outer cylindrical wall of the end is provided with a first annular recess. The first annular recess is internally provided with a first rubber ring. An outer cylindrical wall of the shaft cover is provided with a second annular recess. The second annular recess is internally provided with a second rubber ring.

Further, an outer wall of one end of the first clamping member away from the shaft rod is sleeved with a limiting push table. The limiting push table is annular. An outer diameter of the limiting push table is larger than an aperture of the through hole, allowing the first clamping member to penetrate, provided on the shaft housing.

Further, the shaft housing is further internally provided with a limiting sleeve housing. The limiting sleeve housing has an annular structure. An outer diameter of the limiting sleeve housing is equal to an aperture of the shaft housing. The limiting sleeve housing is located between two bearings. Two ends of the limiting sleeve housing are connected to outer rings of the two bearings respectively.

Further, the shaft sleeve is internally provided with a travel cavity and a non-circular connection through hole. One end, connected to the shaft sleeve, of the shaft rod is provided with an insertion rod part matched with the non-circular connection through hole. The insertion rod part of the shaft rod penetrates the travel cavity and is inserted into the non-circular connection through hole of the shaft sleeve.

Further, the shaft rod is fixedly provided with a limiting member, and the limiting member is located close to the middle of the shaft rod. One end of the shaft rod body part close to the insertion rod part is provided with a third annular recess, and the third annular recess is internally provided with a third rubber ring. An inner wall of one end of the shaft sleeve away from the shaft rod is provided with a fourth annular recess, and the fourth annular recess is internally provided with a fourth rubber ring.

Compared with the prior art, the present disclosure has the beneficial effects:
1. The rotating shaft structure for a polisher according to the present disclosure can facilitate replacement of a polishing rod during use, such that user operation can be facilitated, and user experience can be improved.
2. According to the rotating shaft structure for a polisher according to the present disclosure, through arrangement of the shaft sleeve, the shaft rod can be connected to a polisher motor more stably, such that assembly can be facilitated. Meanwhile, the shaft sleeve has a vibration damping function, such that the polisher is high in operation stability and low in operation noise.

### BRIEF DESCRIPTION OF DRAWINGS

FIG. 1 is a schematic diagram of a solid structure according to the present disclosure.

FIG. 2 is a cutaway view of an overall structure according to the present disclosure.

FIG. 3 is a separation diagram of a first clamping member, a second clamping member and a third clamping member according to the present disclosure.

FIG. 4 is a cutaway view when a first clamping member, a second clamping member and a third clamping member clamp a polishing rod according to the present disclosure.

FIG. 5 is a separation diagram of a first clamping member, a second clamping member and a third clamping member from a shaft rod and a shaft sleeve according to the present disclosure.

FIG. 6 is a schematic diagram of an internal structure of a shaft housing according to the present disclosure.

In the figures: 1, shaft rod; 101, insertion rod part; 2, shaft sleeve; 201, travel cavity; 202, non-circular connection through hole; 3, shaft housing; 4, first clamping member; 5, second clamping member; 6, third clamping member; 601, first tubular part; 602, second tubular part; 603, third tubular part; 604, openable seam; 605, protruding structure; 7, bearing; 8, positioning ring; 9, second spring; 10, shaft cover; 11, first rubber ring; 12, second rubber ring; 13, limiting sleeve housing; 14, limiting push table; 15, limiting member; 16, third rubber ring; 17, fourth rubber ring; 18, polishing rod; 19, first spring.

### DETAILED DESCRIPTION OF THE EMBODIMENTS

In the present disclosure, unless expressly specified and defined otherwise, the terms “mount”, “connect”, “connected”, “fix”, etc. are to be construed broadly and, for instance, may be fixedly connected, or detachably connected, or integrated, may be mechanically connected, or electrically connected, and may be directly connected, or indirectly connected by means of an intermediary medium, including communication between interiors of two elements or interaction between two elements. Those of ordinary skill in the art can understand the specific meanings of the above terms in the present disclosure on a case-by-case basis.

Illustration will be further provided below with reference to accompanying drawings and specific examples:

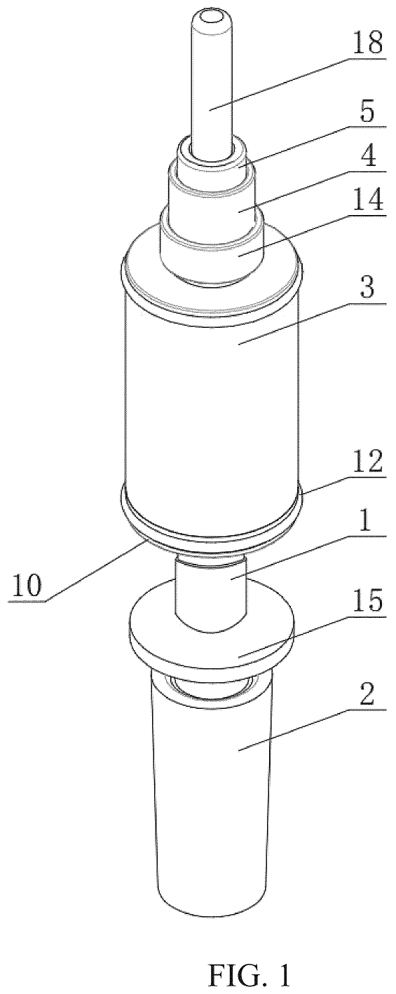

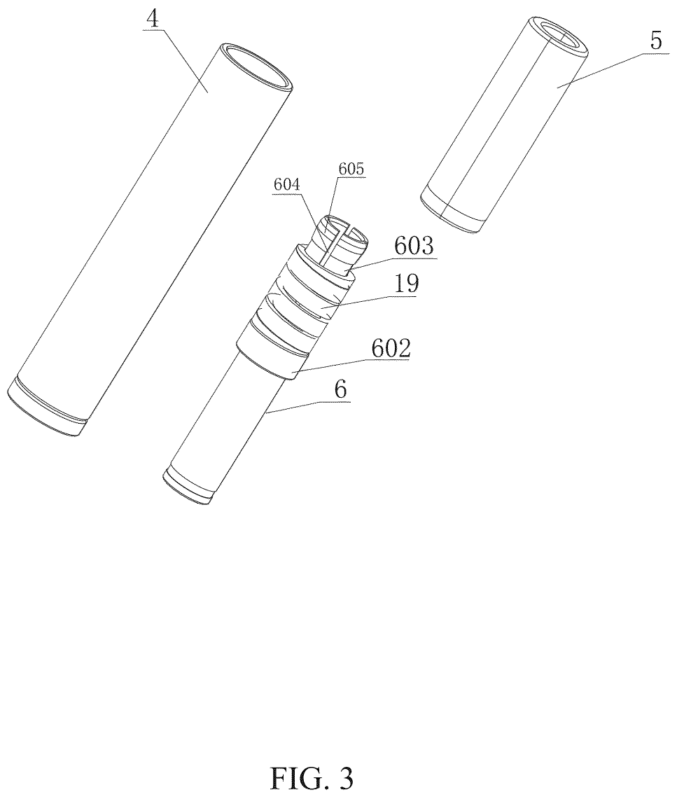

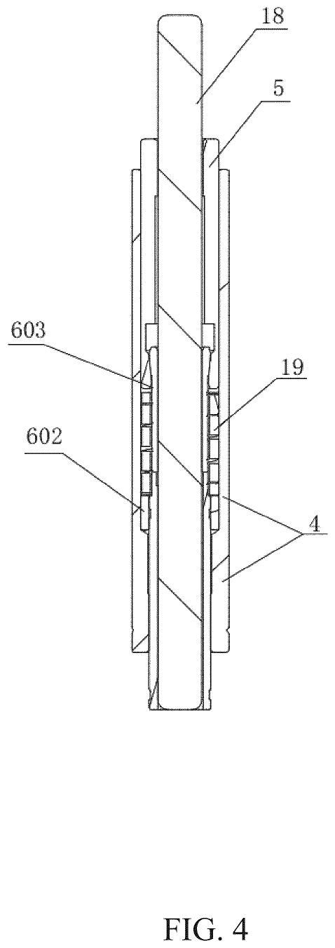

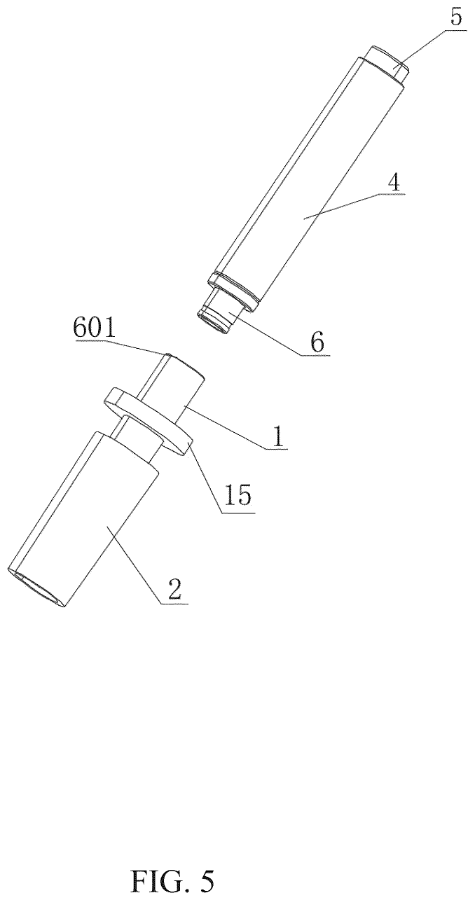

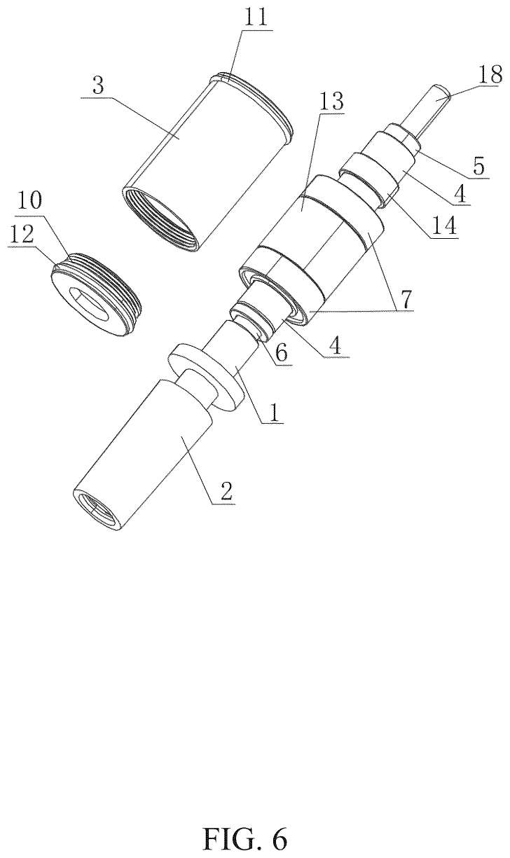

As shown in FIGS. 1-6, a rotating shaft structure for a polisher includes a shaft rod 1, a shaft sleeve 2, a shaft housing 3, a first clamping member 4, a second clamping member 5, and a third clamping member 6. The shaft sleeve 2 is configured to connect a motor shaft and the shaft rod 1. The shaft sleeve 2 is internally provided with a travel cavity 201 and a non-circular connection through hole 202. The travel cavity 201 is located at one end connected to the shaft rod 1. The non-circular connection through hole 202 may be cross-shaped, triangular, regular hexagonal, spline-shaped, etc. One end, connected to the shaft sleeve 2, of the shaft rod 1 is provided with an insertion rod part 101 matched with the non-circular connection through hole. The insertion rod part 101 of the shaft rod 1 penetrates the travel cavity 201 and is inserted into the non-circular connection through hole 202 of the shaft sleeve 2, such that the shaft rod 1 can rotate synchronously with the shaft sleeve 2. The shaft rod 1 is fixedly provided with a limiting member 15. The limiting member 15 is located close to the middle of the shaft rod 1. Through arrangement of the travel cavity 201 and the limiting member 15, the shaft sleeve 2 and the shaft rod 1 have a certain relative moving space in an axial direction, such that vibration damping is achieved. A shaft rod body part is arranged between the insertion rod part 101 and the limiting member 15. One end of the shaft rod body part close to the insertion rod part 101 is provided with a third annular recess. The third annular recess is internally provided with a third rubber ring 16. An inner wall of one end of the shaft sleeve 2 away from the shaft rod 1 is provided with a fourth annular recess. The fourth annular recess is internally provided with a fourth rubber ring 17. The third rubber ring 16 and the fourth rubber ring 17 have functions of sealing and vibration reduction.

As shown in FIGS. 1-6, one end of the shaft housing 3 close to the shaft rod 1 is provided with an opening, and an inner wall of the end is provided with a threaded structure. A shaft cover 10 is mounted on the threaded structure in a threaded manner. Through arrangement of the shaft cover 10, assembly of internal components can be facilitated, and meanwhile, a problem that dust enters the shaft housing 3 and influences a use effect of bearings 7 can be solved, and noise during operation of the bearings 7 can be isolated and reduced. A middle portion of the shaft cover 10 is provided with a through hole allowing the first clamping member 4 to penetrate. One end of the shaft housing 3 away from the shaft rod 1 is further provided with a through hole allowing the first clamping member 4 to penetrate, and an outer cylindrical wall of the end is provided with a first annular recess. The first annular recess is internally provided with a first rubber ring 11. An outer cylindrical wall of the shaft cover 10 is provided with a second annular recess. The second annular recess is internally provided with a second rubber ring 12. Through arrangement of the first rubber ring 11 and the second rubber ring 12, vibration with a mounting housing of a nail polisher or other polishing tools can be reduced.

As shown in FIGS. 1-6, one end of the shaft rod 1 is inserted into the shaft sleeve 2 and connected to the shaft sleeve 2 in a synchronously rotating manner, and the other end of the shaft rod 1 is inserted into and connected to the third clamping member 6 in a synchronously rotating manner. One end of the third clamping member 6 away from the shaft rod 1 is provided with an openable clamping mouth. A polishing rod 18 is mounted in the clamping mouth. In this way, a polisher motor rotates to drive the shaft rod 1 to rotate by means of the shaft sleeve 2, and further the third clamping member 6 and the polishing rod 18 are driven to rotate. The shaft housing 3 is internally provided with two bearings 7 and a limiting sleeve housing 13. The limiting sleeve housing 13 has an annular structure. An outer diameter of the limiting sleeve housing 13 is equal to an aperture of the shaft housing 3. The limiting sleeve housing 13 is located between the two bearings 7. Two ends of the limiting sleeve housing 13 are connected to outer rings of the two bearings 7 respectively. The first clamping member 4 is mounted in the two bearings 7, and two ends of the first clamping member 4 penetrate the shaft housing 3 and the shaft cover 10 respectively.

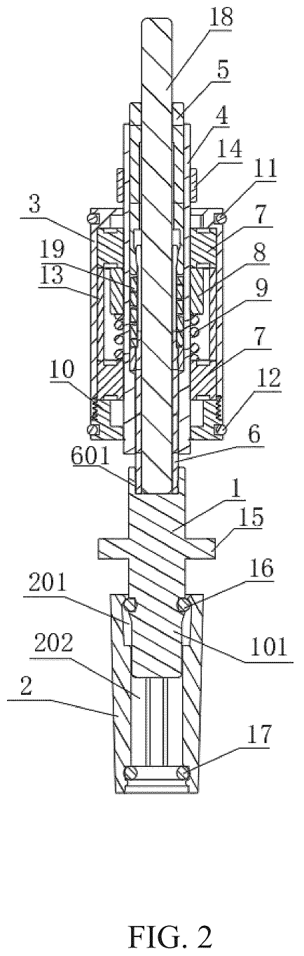

As shown in FIGS. 2-6, the first clamping member 4 is in a hollow tubular shape. The second clamping member 5 and the third clamping member 6 are both located in the first clamping member 4, and the second clamping member 5 is located at one side of the third clamping member 6 away from the shaft rod 1. The first clamping member 4 is fixedly connected to the second clamping member 5. The first clamping member 4 and the third clamping member 6 are slidably connected one after another. One end of the shaft rod 1 is provided with a first tubular part 601. One end of the third clamping member 6 is inserted into the first tubular part 601 and rotates synchronously with the first tubular part 601. The third clamping member 6 further includes a third tubular part 603. One end of the third tubular part 603 opposite the first tubular part 601 is provided with the clamping mouth. A wall of the clamping mouth is provided with a plurality of openable seams 604 in a circumferential direction. The third tubular part rotates synchronously with the first tubular part 601 through fixed connection. An outer wall of the clamping mouth of the third tubular part 603 is provided with a protruding structure 605. The second clamping member 5 is in a hollow tubular shape. One end of the second clamping member 5 extends out of the first clamping member 4, and the other end of the second clamping member 5 sleeves the clamping mouth of the third clamping member 6. The second clamping member 5 is provided with a sleeving mouth having a diameter gradually decreased at the end. Through movement of the sleeving mouth, the protruding structure 605 can be pressed and loosened, and further the openable seams 604 can be opened and closed, that is, a loosened state and a clamped state of the clamping mouth can be implemented. Meanwhile, a linkage state of the third clamping member 6 and the second clamping member 5 is also formed, and rotation of the third clamping member 6 synchronously links rotation of the second clamping member 5. The third clamping member 6 is sleeved with a first spring 19. The third clamping member 6 includes a second tubular part 602 arranged on an outer wall of the third clamping member 6. One end of the first spring 19 elastically abuts against the second tubular part 602, and the other end of the first spring 19 elastically abuts against the second clamping member 5. The first spring 19 abuts against the second clamping member 5 by means of the second tubular part 602 of the third clamping member 6, and an inner wall of the second clamping member 5 presses the clamping mouth of the third clamping member 6, such that the clamping mouth of the third clamping member 6 contracts to be in a clamped state. That is, the clamping mouth clamps the polishing rod 18. The first clamping member 4 includes a first mounting tubular part and a second mounting tubular part. An aperture of the first mounting tubular part is larger than an aperture of the second mounting tubular part. The second tubular part 602 and the third tubular part 603 of the third clamping member 6 are both completely located in the first mounting tubular part. An outer diameter of the second tubular part 602 is larger than the aperture of the second mounting tubular part. A length of the second tubular part 602 is L1. A distance between the second tubular part 602 and the protruding structure 605 is L2. The first clamping member 4 is fixedly connected to the second clamping member 5. The second clamping member 5 is arranged in the first mounting tubular part of the first clamping member 4. A distance between the second clamping member 5 and the second mounting tubular part is L3. L3 satisfies the following formula: L3<L1+L2. In this way, the second clamping member 5 cannot be separated from the third tubular part 603 of the third clamping member 6.

As shown in FIGS. 1, 2 and 3, the shaft housing 3 is further provided with a positioning ring 8 and a second spring 9. The second spring 9 is sleeved with the limiting sleeve housing 13. The positioning ring 8 and the second spring 9 both sleeve the first clamping member 4, and the positioning ring 8 moves synchronously with the first clamping member 4. The second spring 9 is pressed between the positioning ring 8 and the bearing 7 close to the shaft rod 1. The positioning ring 8 is arranged between the two bearings 7, and the positioning ring 8 is in contact with the adjacent bearing 7. The two bearings 7 are fixedly connected to the first clamping member 4. Through arrangement of the two bearings 7, operation stability of the entire rotating shaft structure is increased. An outer wall of one end of the first clamping member 4 away from the shaft rod 1 is sleeved with a limiting push table 14, and the first clamping member and the limiting push table move synchronously. The limiting push table 14 is annular. An outer diameter of the limiting push table 14 is larger than an aperture of the through hole, allowing the first clamping member 4 to penetrate, provided on the shaft housing 3, such that the limiting push table 14 cannot enter the shaft housing 3. Movement of the first clamping member 4 in an axial direction is limited within a certain range through cooperation of the limiting push table 14, the second tubular part 602 and a step structure formed at a joint of the first mounting tubular part and the second mounting tubular part.

A working principle of the present disclosure is as follows: a polishing rod 18 is mounted in a clamping mouth of a third clamping member 6, a shaft sleeve 2 drives a shaft rod 1 to rotate when a polisher motor rotates, the shaft rod 1 rotates to drive a third clamping member 6, a second clamping member 5 and a first clamping member 4 to rotate, and the third clamping member 6 rotates to drive the polishing rod 18 to rotate, such that a nail or other objects can be polished. For replacement of the polishing rod 18, a limiting push table 14 is pushed, and the limiting push table 14 drives the first clamping member 4, the second clamping member 5, a positioning ring 8, two bearings 7 and a shaft housing 3 to move synchronously. A certain avoidance space exists between the first clamping member 4 and the shaft rod 1, such that the third clamping member 6 may slide toward the shaft rod 1 for a certain distance. The second clamping member 5 moves to press a first spring 19. The first spring 19 is compressed, and meanwhile, a sleeving mouth of the second clamping member 5 releases a protruding structure 605 of the third clamping member 6, such that openable seams 604 are opened. In this way, the polishing rod 18 may be taken and replaced. After the polishing rod 18 is replaced, the first clamping member 4 and the limiting push table 14 are loosened. Under reset action of the first spring 19, the first spring 19 pushes the second clamping member 5, so as to synchronously link the first clamping member 4, the positioning ring 8, the two bearings 7 and the shaft housing 3 to return to original positions, and meanwhile, the second clamping member 5 is pushed or pressed, such that the sleeving mouth of the second clamping member 5 clamps the protruding structure 605 of the third clamping member 6, and the openable seams 604 are closed. In this way, the polishing rod 18 may be clamped.

In conclusion, the rotating shaft structure for a polisher according to the present disclosure can facilitate replacement of a polishing rod 18 during use, such that user operation can be facilitated, and user experience can be improved. According to the rotating shaft structure for a polisher according to the present disclosure, through arrangement of the shaft sleeve 2, the shaft rod 1 can be connected to a polisher motor more stably, such that assembly can be facilitated. Meanwhile, the shaft sleeve has a vibration damping function, such that the polisher is high in operation stability and low in operation noise.

What are described above are merely preferred examples of the present disclosure and are not intended to limit the present disclosure, and those skilled in the art can make various modifications and changes to the present disclosure. Any modification, equivalent substitution, improvement, etc. within the spirit and principle of the present disclosure shall fall within the protection scope of the present disclosure.

What is claimed is:

1. A rotating shaft structure for a polisher, comprising a shaft rod and a shaft sleeve, and further comprising a shaft housing, a first clamping member, a second clamping member, and a third clamping member, wherein one end of the shaft rod is connected to the shaft sleeve, the other end of the shaft rod is connected to the third clamping member, and one end of the third clamping member away from the shaft rod is provided with an openable clamping mouth; the first clamping member is in a hollow tubular shape, the second clamping member and the third clamping member are both located in the first clamping member, the second clamping member is located at one side of the third clamping member away from the shaft rod, one end of the second clamping member sleeves the clamping mouth of the third clamping member, the first clamping member and the third clamping member are slidably connected one after another, the third clamping member is sleeved with a first spring, the third clamping member comprises a second tubular part arranged on an outer wall of the third clamping member, one end of the first spring elastically abuts against the second tubular part, and the other end of the first spring elastically abuts against the second clamping member; and the first spring abuts against the second clamping member by means of the second tubular part of the third clamping member, and an inner wall of the second clamping member presses the clamping mouth of the third clamping member, such that the clamping mouth of the third clamping member contracts to be in a clamped state.

2. The rotating shaft structure for a polisher according to claim 1, wherein one end of the shaft rod is provided with a first tubular part, and one end of the third clamping member is inserted into the first tubular part and rotates synchronously with the first tubular part; and the third clamping member further comprises a third tubular part, one end of the third tubular part opposite the first tubular part is provided with the clamping mouth, and a wall of the clamping mouth is provided with a plurality of openable seams in a circumferential direction.

3. The rotating shaft structure for a polisher according to claim 2, wherein an outer wall of the clamping mouth of the third tubular part is provided with a protruding structure, the second clamping member is in a hollow tubular shape, one end of the second clamping member extends out of the first clamping member, and the end, sleeving the clamping mouth, of the second clamping member is provided with a sleeving mouth having a diameter gradually decreased.

4. The rotating shaft structure for a polisher according to claim 3, wherein the first clamping member comprises a first mounting tubular part and a second mounting tubular part, and an aperture of the first mounting tubular part is larger than an aperture of the second mounting tubular part; and the second tubular part and the third tubular part of the third clamping member are both completely located in the first mounting tubular part, an outer diameter of the second tubular part is larger than the aperture of the second mounting tubular part, a length of the second tubular part is L1, a distance between the second tubular part and the protruding structure is L2, the first clamping member is fixedly connected to the second clamping member, the second clamping member is arranged in the first mounting tubular part of the first clamping member, a distance between the second clamping member and the second mounting tubular part is L3, and L3 satisfies the following formula: L3<L1+L2.

5. The rotating shaft structure for a polisher according to claim 1, wherein the shaft housing is internally provided with two bearings, the first clamping member is mounted in the two bearings, and two ends of the first clamping member penetrate two ends of the shaft housing; the shaft housing is further provided with a positioning ring and a second spring, the positioning ring and the second spring both sleeve the first clamping member, and the second spring is pressed between the positioning ring and the bearing close to the shaft rod; and
one end of the shaft housing close to the shaft rod is provided with an opening, an inner wall of the end is provided with a threaded structure, a shaft cover is mounted on the threaded structure in a threaded manner, and a middle portion of the shaft cover is provided with a through hole allowing the first clamping member to penetrate.

6. The rotating shaft structure for a polisher according to claim 5, wherein one end of the shaft housing away from the shaft rod is provided with a through hole allowing the first clamping member to penetrate, an outer cylindrical wall of the end is provided with a first annular recess, and the first annular recess is internally provided with a first rubber ring; and an outer cylindrical wall of the shaft cover is provided with a second annular recess, and the second annular recess is internally provided with a second rubber ring.

7. The rotating shaft structure for a polisher according to claim 6, wherein an outer wall of one end of the first clamping member away from the shaft rod is sleeved with a limiting push table, the limiting push table is annular, and an outer diameter of the limiting push table is larger than an aperture of the through hole, allowing the first clamping member to penetrate, provided on the shaft housing.

8. The rotating shaft structure for a polisher according to claim 1, wherein the shaft housing is further internally provided with a limiting sleeve housing, the limiting sleeve housing has an annular structure, an outer diameter of the limiting sleeve housing is equal to an aperture of the shaft housing, the limiting sleeve housing is located between two bearings, and two ends of the limiting sleeve housing are connected to outer rings of the two bearings respectively.

9. The rotating shaft structure for a polisher according to claim 1, wherein the shaft sleeve is internally provided with a travel cavity and a non-circular connection through hole, one end, connected to the shaft sleeve, of the shaft rod is provided with an insertion rod part matched with the non-circular connection through hole, and the insertion rod part of the shaft rod penetrates the travel cavity and is inserted into the non-circular connection through hole of the shaft sleeve.

10. The rotating shaft structure for a polisher according to claim 9, wherein the shaft rod is fixedly provided with a limiting member, and the limiting member is located close to the middle of the shaft rod; a shaft rod body part is arranged between the insertion rod part and the limiting member, one end of the shaft rod body part close to the insertion rod part is provided with a third annular recess, and the third annular recess is internally provided with a third rubber ring; and an inner wall of one end of the shaft sleeve away from the shaft rod is provided with a fourth annular recess, and the fourth annular recess is internally provided with a fourth rubber ring.
